(19) United States
(12) Patent Application Publication
(10) Pub. No.: US 2014/0210128 A1
(43) Pub. Date: Jul. 31, 2014

(54) POLYMER INTERLAYERS COMPRISING SKIN LAYERS

(71) Applicant: Solutia Inc., St. Louis, MO (US)

(72) Inventors: Chiah-chang Clifford Lin, Longmeadow, MA (US); John Joseph D'Errico, Glastonbury, CT (US); Ping Yuan, Amherst, MA (US)

(73) Assignee: SOLUTIA INC., St. Louis, MO (US)

(21) Appl. No.: 14/230,960

(22) Filed: Mar. 31, 2014

Related U.S. Application Data
(63) Continuation of application No. 12/725,079, filed on Mar. 16, 2010, now abandoned.
Application No. 12/725,079 is a continuation of application No. 11/087,987, filed on Mar. 24, 2005, now abandoned.

(51) Int. Cl. B29C 47/06

(52) U.S. Cl. CPC B29C 47/065
USPC 264/173.11; 264/173.16

(57) ABSTRACT

The present invention is in the field of polymer interlayers used in multiple layer glass panels, and specifically the present invention is in the field of various performance enhancing agents for polymer interlayers and methods of effectively incorporating such performance enhancing agents into interlayers.

### RELATED APPLICATION(S)

This application is a continuation of U.S. application Ser. No. 12/725,079, filed Mar. 16, 2010, which is a continuation of U.S. application Ser. No. 11/087,987, filed Mar. 24, 2005 which is now abandoned. The entire teachings of the above applications are incorporated herein by reference.

### FIELD OF INVENTION

The present invention is in the field of polymer interlayers used in multiple layer glass panels, and specifically the present invention is in the field of various performance enhancing agents for polymer interlayers and methods of effectively incorporating such performance enhancing agents into interlayers.

### BACKGROUND OF THE INVENTION

Poly(vinyl butyral) (PVB) is commonly used in the manufacture of polymer sheets that can be used as interlayers in light-transmitting laminates such as safety glass or polymeric laminates. Safety glass typically refers to a transparent laminate comprising a poly(vinyl butyral) sheet disposed between two panes of glass. Safety glass often is used to provide a transparent barrier in architectural and automotive openings. Its main function is to absorb energy, such as that caused by a blow from an object, without allowing penetration through the opening.

Poly(vinyl butyral) is commonly produced through, for example, extrusion processes. Extrusion results in the formation of a continuous sheet of poly(vinyl butyral). Various agents are often incorporated directly into the poly(vinyl butyral) in bulk prior to extrusion. Agents that are incorporated into poly(vinyl butyral) in this manner are generally dispersed throughout the finished polymer sheet, which is often not a desirable result. Further, because polymer sheets having disparate characteristics can require the use of a different set of agents, a significant amount of time and money can be lost changing over poly(vinyl butyral) formulations in extrusion devices between production runs.

Accordingly, further improved polymer sheets and methods for the production of polymer sheets, and specifically poly(vinyl butyral) sheets, are needed, without adversely affecting the optical clarity of the finished laminates of the glass or adhesion properties of the resulting poly(vinyl butyral) sheet to glass.

### SUMMARY OF THE INVENTION

It has now been surprisingly discovered, according to the present invention, that the use of polymer sheet skin layers or the formation of a skin layer region in a polymer sheet allows the production of interlayers having desirable characteristics without the need to distribute those agents in bulk throughout a polymer sheet.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 represents a schematic cross sectional view of one embodiment of the present invention having a polymer sheet skin layer.

FIG. 2 represents a schematic cross sectional view of one embodiment of the present invention having two polymer sheet skin layers.

FIG. 3 represents a schematic cross sectional view of one embodiment of the present invention having a skin layer region.

### DETAILED DESCRIPTION OF THE INVENTION

The present invention is directed to interlayers that can be used in multiple layer laminated glass constructs such as those used in architectural applications and automotive windshield applications. Interlayers of the present invention incorporate a very thin polymer sheet skin layer, or, in some embodiments, a skin layer region within a single polymer sheet, to provide desirable characteristics to the interlayer without the necessity of adding performance enhancing agents in bulk to the entire interlayer.

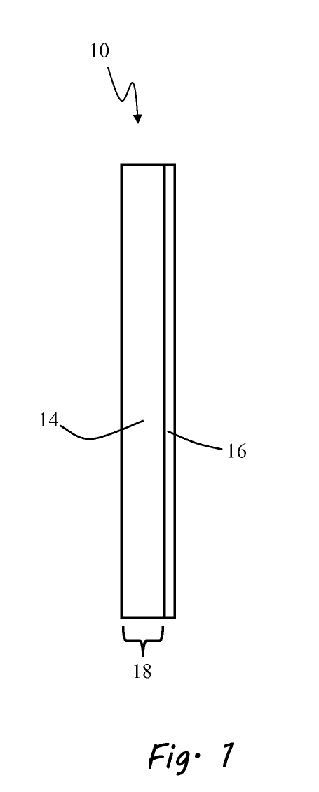

As shown in FIG. 1, various embodiments of the present invention comprise a polymer stack 18 comprising a first polymer sheet 14 disposed in contact with a second polymer sheet 16 to form an interlayer 10. As will be described in detail below, the polymer sheets can comprise any suitable polymeric material, such as poly(vinyl butyral). As used herein, a “polymer stack” means one or more layers of polymeric materials, and optionally other layers, that are disposed in contact with one another to form a stack, wherein at least one of the layers is a polymer sheet. A polymer stack can be, as shown in FIG. 1, a single polymer sheet, or, in other embodiments, a polymer stack can comprise two or more layers of polymer sheets and polymer films (described elsewhere herein), among other types of layers.

The second polymer sheet 16 comprises one or more performance enhancing agents and, in various embodiments, has a thickness of less than 0.4 millimeters, 0.3 millimeters, or 0.25 millimeters. The first polymer sheet 14 can be any suitable thickness so that, in combination with the other layers of the polymer stack 18, if any, an interlayer 10 is formed that is of the desired thickness. The total interlayer thickness can be, for example, about 1.5 millimeters. The first polymer sheet 14 can contain, for example, no performance enhancing agents, or can be substantially free of performance enhancing agents. In various embodiments, the first polymer sheet has less than 10%, less than 5%, or less than 1% of the performance enhancing agent of the second polymer sheet, on a weight per weight basis.

In the configuration shown in FIG. 1, an interlayer of the present invention provides a construct that allows for the concentration of performance enhancing agents on an outside surface of an interlayer rather than the conventional distribution of a performance enhancing agent throughout an interlayer.

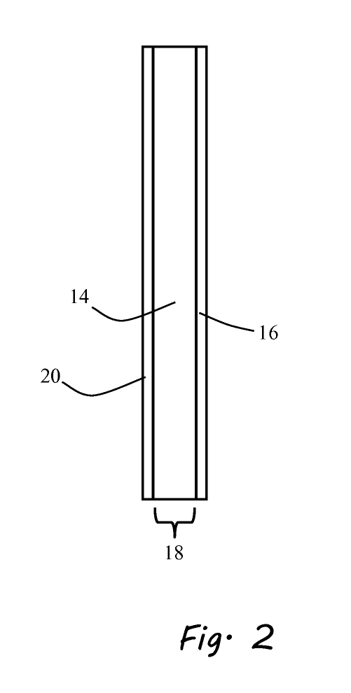

As shown in FIG. 2, various embodiments of the present invention utilize a third polymer sheet 20 disposed in contact with the polymer stack 18, which again, for simplicity, is shown as comprising only a single polymer sheet 14. As above, however, the polymer stack 18 can comprise multiple polymeric layers and/or other layers. In these embodiments, the third polymer sheet 20 can be the same as the second polymer sheet 16, or it can be different. The third polymer sheet 20 can have the same compositions and range of thicknesses as the second polymer sheet 16, as given above.

Although the polymer stack 18 in any of the above embodiments can comprise no or substantially no performance enhancing agents, in various embodiments any of the polymer sheet layers in the polymer stack 18 can comprise intentionally added performance enhancing agents in a lesser concentration than is found in the second or third polymer sheets 16, 20. In addition to the intentional addition of performance enhancing agents to one or more polymer sheets within the polymer stack 18, it is expected that some performance enhancing agent, after lamination of the interlayer, can migrate from the second or third polymer sheets 16, 20 into the first polymer sheet 14 and/or any other polymer sheets in the polymer stack 18. This generally results in an insubstantial amount of performance enhancing agent in the polymer stack 18.

For the above described embodiments, as shown in FIGS. 1 and 2, the polymer stack 18 can comprise any conventional configuration of layers. For example, and without limitation, the polymer stack 18 can have the following configurations, where n represents 1 to 10 iterations, and preferably 1, 2, or 3 iterations:
(polymer sheet)ₙ
(polymer sheet//polymer film)ₙ
(polymer film//polymer sheet)ₙ
(polymer sheet//polymer film//polymer sheet)ₙ
(polymer film//polymer sheet//polymer film)ₙ

Of course, many other arrangements are possible and within the scope of the present invention, which includes embodiments incorporating the second polymer sheet 16 or the second and third polymer sheets 16, 20 into any suitable polymer stack 18.

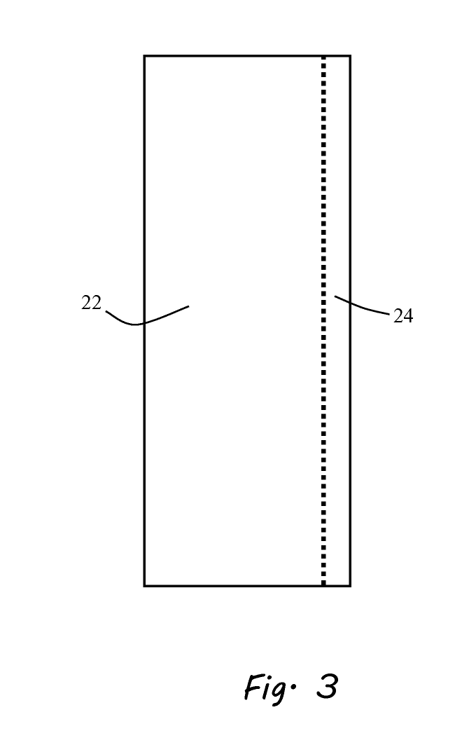

In addition to providing relatively thin polymer sheet layers, the present invention also includes polymer sheets that comprise a relatively thin agent region (i.e. skin layer region) within the sheet and adjacent an exposed surface. As shown in FIG. 3, a polymer sheet having an agent region 24 and a non agent region 22 can be produced, wherein the agent region comprises one or more performance enhancing agents. Such a sheet can be produced, for example, by coextruding two polymer melts, as described elsewhere herein. The resulting polymer sheet can effectively provide a similar performance enhancing agent concentration effect as the multiple layer interlayer shown in FIG. 1 by concentrating performance enhancing agents in a relatively narrow region.

For the embodiment shown in FIG. 3, the agent region 24 is formed so as to emulate a separate layer within the polymer sheet, and can have a thickness of less than 0.4 millimeters, less than 0.3 millimeters, less than 0.25 millimeters, less than 0.2 millimeters, or less than 0.15 millimeters. The non agent region 22 can have any suitable thickness as desired to form a polymer sheet of the appropriate thickness for any given application. Further, the non agent region can comprise an amount of performance enhancing agent that is less than the amount in the agent region, or can have no performance enhancing agent or be substantially free of performance enhancing agent, wherein any performance enhancing agent that migrates into the non agent region 22 from the agent region 24 is generally insubstantial. In various embodiments, the non agent region 22 has less than 10%, less than 5%, or less than 1% of the performance enhancing agent of the agent region 24, on a weight per weight basis.

In further embodiments, the polymer sheet shown in FIG. 3 can be used as a single layer in a multiple layer interlayer. For example, a polymer film can be disposed between two of the polymer sheets, with the agent regions facing out, to form a three layer interlayer having an agent region on each exposed surface.

In further embodiments of the present invention, three separate regions are formed in a polymer sheet—two agent regions and one non agent region—for example by coextruding three polymer melts. In these embodiments, a second agent region is formed in the polymer sheet on the face of the polymer sheet opposite the agent region 24 shown in FIG. 3 to form a single polymer sheet having three regions that emulate the layout of the embodiments shown in FIG. 2, wherein a central non agent region is disposed between two agent regions. In these embodiments, the two agent regions can be the same or different—i.e. both agent regions can have the thicknesses and characteristics described above for the agent region 24. These embodiments provide a single polymer sheet that advantageously has performance enhancing agents concentrated at the surfaces of the sheet.

In the coextrusion embodiments described herein, the non agent region 22 can vary in thickness from relatively thick, for example, 1 millimeter, to very thin, for example, 0.125 millimeters. In various embodiments, the non agent region 22 is less than 0.2 millimeters or 0.15 millimeters, and one or both agent regions 24 have a thickness of between 0.3 and 0.5 millimeters or 0.35 and 0.45 millimeters.

Any of the embodiments described above and depicted in FIGS. 1, 2, and 3 can be used as interlayers, or, in various embodiments, combined with conventional layers to produce multiple layered interlayers. In particular, embodiments in which a single polymer sheet or agent region comprising performance enhancing agents is used can be combined with additional layers of polymer film or polymer sheet, as desired, among other types of layers.

In various embodiments of the present invention, an interlayer can be formed that comprises a polymer stack//polymer sheet such as that shown in FIG. 1 and a polymer sheet with an polymer agent region such as that shown in FIG. 3.

### Performance Enhancing Agents

Interlayers of the present invention having a skin layer, or an agent region within a polymer sheet, include at least a first performance enhancing agent in the skin layer or agent region, wherein the adjacent polymer sheet or non agent region is substantially free of that first performance enhancing agent.

As used herein, a “performance enhancing agent” can be any agent present in a polymer sheet that is added to improve physical, optical, or other properties of the finished product, other than the polymer, for example, poly(vinyl butyral) resin, plasticizers, and components that are produced as part of the polymerization process and are not intentionally added as a performance enhancing agent, for example residual acetates and alcohols.

In various embodiments of the present invention, other performance enhancing agents can be included in the skin layer or agent region but not in the adjacent polymer sheet or non agent region. For example, combinations of 2, 3, 4, or 5 or more performance enhancing agents can be included in one or more skin layers or one or more agent regions, wherein the adjoining polymer sheets and non agent regions are substantially free of those same performance enhancing agents, or where those agents are present at less than 10%, less than 5%, or less than 1% of the amount of performance enhancing agent in the skin layers or agent regions.

In yet further embodiments, while at least one performance enhancing agent is present in the skin layer or agent region but not in the adjoining layer or region, a different performance enhancing agent can be distributed in both adjoining polymer sheets or in both the agent and non agent region. For example, in a coextruded embodiment having one agent region and one non agent region, the agent region can comprise performance enhancing agent A and performance enhancing agent B, while the non agent region is substantially free of performance enhancing agent A, but does comprise performance enhancing agent B.

Performance enhancing agents that are useful with the present invention include adhesion control agents (ACAs), including organometallics, colorants such as pigments and dyes, UV absorbers, IR absorbers, impact modifier or inorganic filler.

Useful adhesion control agents include, but are not limited to, organic alkali or alkaline earth metal salts, such as sodium acetate, potassium acetate, potassium formate, calcium acetate, magnesium acetate, and others conventionally used in the art. In other embodiments, magnesium organic salts having the formula of Mg(OCOR)₂ are used, where R is an alkyl group. In various embodiments, magnesium di-2-ethyl butyrate (RSS4) is used as an adhesion control agent.

Useful adhesion control agents also include various type of silane coupling agents. Examples of silane coupling agents include am inopropyltriethyoxysilane, glycidoxypropyltrimethoxysilane, and triethoxyvinylsilane.

Performance enhancing agents of the present invention also include ultraviolet absorbers, such as benzotriazoles and benzophenones, and, in various embodiments, the ultraviolet absorbs are derivatives of benzotriazole, such as Tinuvin 326, Tinuvin 328 and Tinuvin P. The effective amount of ultraviolet absorber agent will depend upon the particular resin and plasticizer used, and can be, for example, from 0.1 to 1.0 phr.

Examples of useful infrared absorbing agents include, but are not limited to, lanthanum hexaboride (LaB6), indium tin oxide (ITO), antimony tin oxide (ATO), cesium tungsten (CsW03), and organic IR absorbing additives, such as the various derivatives of quaterrylenetetracarboxylic diimide, as disclosed in U.S. Pat. No. 6,737,159.

Performance enhancing agents of the present invention also include colorants such as conventional pigments, dyes, and combinations thereof.

Other performance enhancing agents include optical brighteners and fluorescent whitening agents, as are known in the art. Examples of useful optical brighteners include derivatives of stilbene, coumarine, 1,3-diphenylpyrazoline, naphthalinide, and benzoxazole. Preferred optical brighteners include, for example, Blankophor PSG.®. (a stilbene derivative—Bayer AG, Bayer AG, 51368 Leverkusen, Germany), Uvitex FP.®. (a stilbene derivative—Ciba-Geigy AG), and Uvitex OB.®. (benzoxazole derivative—Ciba-Geigy AG).

Performance enhancing agents of the present invention also include fire retardants. Examples of fire retardant agents include various inorganic and organic compounds containing phosphorus, silica, and fluorine, such as phosphate esters, silicones, polymer-clay nanocomposites, zinc borates, and combinations thereof among others as are known in the art.

Performance enhancing agents can be included in any appropriate amount, depending on the application. For adhesion control agents, for example, agent can be incorporated into skin layers or agent regions at a concentration of at least 100 ppm, at least 120 ppm, at least 140 ppm, at least 150 ppm, or at least 160 ppm.

In various embodiments, a skin layer or agent region comprises an inorganic agent or an organometallic agent. In various embodiments, a skin layer or region comprises an adhesion control agent, an infrared absorber, or a pigment.

### Polymer Sheet

As used herein, a “polymer sheet” means any thermoplastic polymer composition formed by any suitable method into a thin layer that is suitable alone, or in stacks of more than one layer, for use as an interlayer that provides adequate penetration and glass retention properties to laminated glazing panels. Plasticized poly(vinyl butyral) is most commonly used to form polymer sheets.

The following section describes the various materials that can be used to form polymer sheets of the present invention, for example those sheets shown as elements 14 and 16 in FIG. 1 and any additional polymer sheets that are optionally included.

In various embodiments of the present invention, additional polymer sheet layers can be between 0.25 to 3.0 millimeters, 0.25 to 1.0 millimeters, 0.25 to 0.5 millimeters, or 0.3 to 0.4 millimeters in thickness.

The polymer sheets of the present invention can comprise any suitable polymer, and, in a preferred embodiment, as exemplified above, the polymer sheet comprises poly(vinyl butyral). In any of the embodiments of the present invention given herein that comprise poly(vinyl butyral) as the polymeric component of the polymer sheet, another embodiment is included in which the polymer component consists of or consists essentially of poly(vinyl butyral). In these embodiments, any of the variations in additives, including plasticizers, disclosed herein can be used with the polymer sheet having a polymer consisting of or consisting essentially of poly(vinyl butyral).

In one embodiment, the polymer sheet comprises a polymer based on partially acetalized poly(vinyl alcohol)s. In another embodiment, the polymer sheet comprises a polymer selected from the group consisting of poly(vinyl butyral), polyurethane, polyvinyl chloride, poly(ethylene vinyl acetate), combinations thereof, such as blends, and the like.

In further embodiments the polymer sheet comprises poly(vinyl butyral) and one or more other polymers. In any of the sections herein in which preferred ranges, values, and/or methods are given specifically for poly(vinyl butyral) (for example, and without limitation, for plasticizers, component percentages, thicknesses, and characteristic-enhancing additives), those ranges also apply, where applicable, to the other polymers and polymer blends disclosed herein as useful as components in polymer sheets.

For embodiments comprising poly(vinyl butyral), the poly(vinyl butyral) can be produced by known acetalization processes that involve reacting poly(vinyl alcohol) (PVOH) with butyraldehyde in the presence of an acid catalyst, followed by neutralization of the catalyst, separation, stabilization, and drying of the resin.

In various embodiments, resin used to form the polymer sheet comprising poly(vinyl butyral) comprises 10 to 35 weight percent (wt. %) hydroxyl groups calculated as poly(vinyl alcohol), 13 to 30 wt. % hydroxyl groups calculated as poly(vinyl alcohol), or 15 to 22 wt. % hydroxyl groups calculated as poly(vinyl alcohol). The polymer sheet can also comprise less than 15 wt. % residual ester groups, 13 wt. %, 11 wt. %, 9 wt. %, 7 wt. %, 5 wt. %, or less than 3 wt. % residual ester groups calculated as polyvinyl acetate, with the balance being an acetal, preferably butyraldehyde acetal, but optionally including other acetal groups in a minor amount, e.g., a 2-ethyl hexanal group (see, for example, U.S. Pat. No. 5,137,954).

In various embodiments, the polymer sheet comprises poly(vinyl butyral) having a molecular weight at least 30,000, 40,000, 50,000, 55,000, 60,000, 65,000, 70,000, 120,000, 250,000, or at least 350,000 grams per mole (g/mole or Daltons). Small quantities of a dialdehyde or trialdehyde can also be added during the acetalization step to increase molecular weight to at least 350 g/m (see, for example, U.S. Pat. Nos. 4,902,464; 4,874,814; 4,814,529; 4,654,179). As used herein, the term “molecular weight” means the weight average molecular weight.

Any of the agents provided in this “polymer sheet” section apply specifically to additional polymer sheet layers that are optionally used in interlayers of the present invention.

Various adhesion control agents can be used in polymer sheets of the present invention, including sodium acetate, potassium acetate, and magnesium salts. Magnesium salts that can be used with these embodiments of the present invention include, but are not limited to, those disclosed in U.S. Pat. No. 5,728,472, such as magnesium salicylate, magnesium nicotinate, magnesium di-(2-aminobenzoate), magnesium di-(3-hydroxy-2-napthoate), and magnesium bis(2-ethyl butyrate)(chemical abstracts number 79992-76-0). In various embodiments of the present invention the magnesium salt is magnesium bis(2-ethyl butyrate).

Additives may be incorporated into the polymer sheet to enhance its performance in a final product. Such additives include, but are not limited to, the following agents: antiblocking agents, plasticizers, dyes, pigments, stabilizers (e.g., ultraviolet stabilizers), antioxidants, flame retardants, IR absorbers, and combinations of the foregoing additives, and the like, as are known in the art.

In various embodiments of polymer sheets of the present invention, the polymer sheets can comprise 20 to 60, 25 to 60, 20 to 80, or 10 to 70 parts plasticizer per one hundred parts of resin (phr). Of course other quantities can be used as is appropriate for the particular application. In some embodiments, the plasticizer has a hydrocarbon segment of fewer than 20, fewer than 15, fewer than 12, or fewer than 10 carbon atoms.

The amount of plasticizer can be adjusted to affect the glass transition temperature (T_{g}) of the poly(vinyl butyral) sheet. In general, higher amounts of plasticizer are added to decrease the T_{g}. Poly(vinyl butyral) polymer sheets of the present invention can have a T_{g} of, for example, 40° C. or less, 35° C. or less, 30° C. or less, 25° C. or less, 20° C. or less, and 15° C. or less.

Any suitable plasticizers can be added to the polymer resins of the present invention in order to form the polymer sheets. Plasticizers used in the polymer sheets of the present invention can include esters of a polybasic acid or a polyhydric alcohol, among others. Suitable plasticizers include, for example, triethylene glycol di-(2-ethylbutyrate), triethylene glycol di-(2-ethylhexanoate), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, polymeric plasticizers such as the oil-modified sebacic alkyds, and mixtures of phosphates and adipates such as disclosed in U.S. Pat. No. 3,841,890 and adipates such as disclosed in U.S. Pat. No. 4,144,217, and mixtures and combinations of the foregoing. Other plasticizers that can be used are mixed adipates made from C₄ to C₉ alkyl alcohols and cyclo C₄ to C₁₀ alcohols, as disclosed in U.S. Pat. No. 5,013,779 and C₆ to C₈ adipate esters, such as hexyl adipate. In various embodiments, the plasticizer used is dihexyl adipate and/or triethylene glycol di-2 ethylhexanoate.

Any suitable method can be used to produce the polymer sheets of the present invention. Details of suitable processes for making poly(vinyl butyral) are known to those skilled in the art (see, for example, U.S. Pat. Nos. 2,282,057 and 2,282,026). In one embodiment, the solvent method described in Vinyl Acetal Polymers, in Encyclopedia of Polymer Science & Technology, 3rd edition, Volume 8, pages 381-399, by B. E. Wade (2003) can be used. In another embodiment, the aqueous method described therein can be used. Poly(vinyl butyral) is commercially available in various forms from, for example, Solutia Inc., St. Louis, Mo. as Butvar™ resin.

The poly(vinyl butyral) polymer, plasticizer, and additives can be thermally processed and configured into sheet form according to methods known to those of ordinary skill in the art.

As used herein, “resin” refers to the polymeric (for example poly(vinyl butyral)) component that is removed from the mixture that results from the acid catalysis and subsequent neutralization of the polymeric precursors. Resin will generally have other components in addition to the polymer, for example poly(vinyl butyral), such as acetates, salts, and alcohols. As used herein, “melt” refers to a melted mixture of resin with a plasticizer and optionally other additives, for example, performance enhancing agents.

One exemplary method of forming a poly(vinyl butyral) sheet comprises extruding molten poly(vinyl butyral) comprising resin, plasticizer, and additives—the melt—by forcing the melt through a sheet die (for example, a die having an opening that is substantially greater in one dimension than in a perpendicular dimension). Another exemplary method of forming a poly(vinyl butyral) sheet comprises casting a melt front a die onto a roller, solidifying the resin, and subsequently removing the solidified resin as a sheet.

Performance enhancing agents of the present invention can be incorporated into polymer sheets by adding the performance enhancing agents to a melt and mixing the melt prior to formation of the polymer sheet. For embodiments in which an agent region is formed in a polymer sheet, performance enhancing agents can be added to a first melt which is coextruded with a second melt, wherein the second melt has, for example, no performance enhancing agent added. In other embodiments, a third melt comprising the performance enhancing agent can be coextruded as well to form the three region embodiment described elsewhere herein. The resulting sheets will have agent regions and non agent regions as described elsewhere herein.

### Polymer Film

As used herein, a “polymer film” means a relatively thin and rigid polymer layer that functions as a performance enhancing layer. Polymer films differ from polymer sheets, as used herein, in that polymer films do not themselves provide the necessary impact resistance and glass retention properties to a multiple layer glazing structure, but rather provide performance improvements, such as infrared absorption character. Poly(ethylene terephthalate) is most commonly used as a polymer film.

Polymer films used in the present invention can be any suitable film that is sufficiently rigid to provide a relatively flat, stable surface, for example those polymer films conventionally used as a performance enhancing layer in multiple layer glass panels. The polymer film is preferably optically transparent (i.e. objects adjacent one side of the layer can be comfortably seen by the eye of a particular observer looking through the layer from the other side), and usually has a greater, in some embodiments significantly greater, tensile modulus regardless of composition than that of the adjacent polymer sheet. In various embodiments, the polymer film comprises a thermoplastic material. Among thermoplastic materials having suitable properties are nylons, polyurethanes, acrylics, polycarbonates, polyolefins such as polypropylene, cellulose acetates and triacetates, vinyl chloride polymers and copolymers and the like. In various embodiments, the polymer film comprises materials such as re-stretched thermoplastic films having the noted properties, which include polyesters. In various embodiments, the polymer film comprises or consists of poly(ethylene terephthalate), and, in various embodiments, the polyethylene terephthalate has been biaxially stretched to improve strength, and/or has been heat stabilized to provide low shrinkage characteristics when subjected to elevated temperatures (e.g. less than 2% shrinkage in both directions after 30 minutes at 150° C.).

In various embodiments, the polymer film can have a thickness of 0.013 millimeters to 0.20 millimeters, 0.025 millimeters to 0.1 millimeters, or 0.04 to 0.06 millimeters. The polymer film can optionally be surface treated or coated with a functional performance layer to improve one or more properties, such as adhesion or infrared radiation reflection. These functional performance layers include, for example, a multi-layer stack for reflecting infra-red solar radiation and transmitting visible light when exposed to sunlight. This multi-layer stack is known in the art (see, for example, WO 88/01230 and U.S. Pat. No. 4,799,745) and can comprise, for example, one or more Angstroms-thick metal layers and one or more (for example two) sequentially deposited, optically cooperating dielectric layers. As is also known (see, for example, U.S. Pat. Nos. 4,017,661 and 4,786,783), the metal layer(s) may optionally be electrically resistance heated for defrosting or defogging of any associated glass layers. Various coating and surface treatment techniques for poly(ethylene terephthalate) film and other polymer films that can be used with the present invention are disclosed in published European Application No. 0157030. Polymer films of the present invention can also include a hardcoat and/or and antifog layer, as are known in the art.

The present invention includes methods for concentrating a performance enhancing agent near the surface of an interlayer, comprising forming any of the polymer stack/polymer sheet constructs of the present invention, laminating the construct to form an interlayer, and, optionally, rolling or stacking the interlayer.

The present invention also includes methods for concentrating a performance enhancing agent near the surface of an interlayer, comprising forming a polymer sheet having any of the agent regions/non agent regions described herein, and, optionally, rolling or stacking the polymer sheet.

Also included in the present invention are stacks or rolls of any of the polymer interlayers of the present invention disclosed herein.

The present invention includes multiple layer glazing panels, and specifically multiple layer glass panels such as architectural safety glass and automobile windshields, comprising any of the interlayers of the present invention.

The present invention includes methods of manufacturing an interlayer, comprising using a coextrusion technique to form one or two agent regions within a polymer sheet.

The present invention includes methods of manufacturing a multiple layer glass panel, comprising disposing any of the interlayers of the present invention, with or without additional polymeric layers, between two panes of glass and laminating the stack.

In addition to the embodiments given above, other embodiments comprise a rigid glazing substrate other than glass. In these embodiments, the rigid substrate can comprise acrylic, Plexiglass®, Lexan®, and other plastics, such as polycarbonate, that are conventionally used as glazings.

Various polymer sheet and/or laminated glass characteristics and measuring techniques will now be described for use with the present invention.

The clarity of a polymer sheet, and particularly a poly(vinyl butyral) sheet, can be determined by measuring the haze value, which is a quantification of light not transmitted through the sheet. The percent haze can be measured according to the following technique. An apparatus for measuring the amount of haze, a Hazemeter, Model D25, which is available from Hunter Associates (Reston, Va.), can be used in accordance with ASTM D1003-61 (Re-approved 1977)-Procedure A, using Illuminant C, at an observer angle of 2 degrees. In various embodiments of the present invention, percent haze is less than 5%, less than 3%, and less than 1%.

Pummel adhesion can be measured according to the following technique, and where “pummel” is referred to herein to quantify adhesion of a polymer sheet to glass, the following technique is used to determine pummel. Two-ply glass laminate samples are prepared with standard autoclave lamination conditions. The laminates are cooled to about −17° C. (0° F.) and manually pummeled with a hammer to break the glass. All broken glass that is not adhered to the poly(vinyl butyral) sheet is then removed, and the amount of glass left adhered to the poly(vinyl butyral) sheet is visually compared with a set of standards. The standards correspond to a scale in which varying degrees of glass remain adhered to the poly(vinyl butyral) sheet. In particular, at a pummel standard of zero, no glass is left adhered to the poly(vinyl butyral) sheet. At a pummel standard of 10, 100% of the glass remains adhered to the poly(vinyl butyral) sheet. For laminated glass panels of the present invention, various embodiments have a pummel of at least 3, at least 5, at least 8, at least 9, or 10. Other embodiments have a pummel between 8 and 10, inclusive.

The “yellowness index” of a polymer sheet can be measured according to the following: transparent molded disks of polymer sheet 1 cm thick, having smooth polymeric surfaces which are essentially plane and parallel, are formed. The index is measured according to ASTM method D 1925, “Standard Test Method for Yellowness Index of Plastics” from spectrophotometric light transmittance in the visible spectrum. Values are corrected to 1 cm thickness using measured specimen thickness. In various embodiments of the present invention, a polymer sheet can have a yellowness index of 12 or less, 10 or less, or 8 or less.

Blocking can be measured according to the following technique, and, as used and referred to herein, “blocking force” is determined using the following technique, which is a measure of “peel adhesion.” Two rectangular filmstrips are cut and placed together in completely overlapping pairs. The top sheet of each pair is adhered to a piece of tape of a corresponding size. The film pairs are placed centrally between two steel plates and the assembly is subjected to 69 kilo Pascal pressure at a temperature range of about 7° C.-25° C. for 24 hours. The strips can then be peeled apart in a 90-degree peel test by a peel testing apparatus at a peel speed of 84 inches per minute. The blocking force is quantified in pounds per linear inch (PLI). In various embodiments, polymer sheets have a blocking force of less than 2.5 pounds per linear foot (PLI), less than 2.25 PLI, less than 2.0 PLI, than 1.0 PLI, or less than 0.1 PLI.

By virtue of the present invention, it is now possible to provide interlayers having one or more performance enhancing agents distributed advantageously at the surface of an interlayer. This can result in more efficient use of performance enhancing agent as well as more efficient changeover time between production runs.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

It will further be understood that any of the ranges, values, or characteristics given for any single component of the present invention can be used interchangeably with any ranges, values, or characteristics given for any of the other components of the invention, where compatible, to form an embodiment having defined values for each of the components, as given herein throughout. For example, a polymer sheet can be formed comprising agents in any of the ranges given in addition to any of the ranges given for plasticizer, to form many permutations that are within the scope of the present invention.

Figures are understood to not be drawn to scale unless indicated otherwise. Each reference, including journal articles, patents, applications, and books, referred to herein is hereby incorporated by reference in its entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method for making a polymer interlayer, comprising:
a) extruding a first poly(vinyl butyral) melt to form a poly(vinyl butyral) sheet; and
b) co-extruding a second poly(vinyl butyral) melt to form a first skin layer on the surface of said poly(vinyl butyral) sheet, wherein said second melt contains a first performance enhancing agent and wherein said first skin layer has a thickness of less than 0.15 millimeters and wherein said first melt is substantially free of said performance enhancing agent.

2. The method of claim 1, wherein said first performance enhancing agent is selected from the group consisting of adhesion control agents, pigments, dyes, UV absorbers, and infrared absorbers.

3. The method of claim 1, wherein said first performance enhancing agent is selected from the group consisting of adhesion control agents, infrared absorbers, and pigments.

4. The method of claim 3, wherein said first performance enhancing agent is an adhesion control agent.

5. The method of claim 3, wherein said first performance enhancing agent is an infrared absorber.

6. The method of claim 3, wherein said first performance enhancing agent is a pigment.

7. The method of claim 1 further comprising:
c) co-extruding a third poly(vinyl butyral) melt to form a second skin layer on the surface of said poly(vinyl butyral) sheet, opposite to said first skin layer, and having a thickness of less than 0.15 millimeters, wherein said third melt contains a second performance enhancing agent.

8. The method of claim 7, wherein the first performance enhancing agent and the second performance enhancing agent are different performance enhancing agents.

9. The method of claim 7, wherein the first performance enhancing agent and the second performance enhancing agent are the same performance enhancing agents.

10. The method of claim 7, wherein the second performance enhancing agent is selected from the group consisting of adhesion control agents, pigments, dyes, UV absorbers, and infrared absorbers.

11. The method of claim 7, wherein said second performance enhancing agent in the third melt is selected from the group consisting of adhesion control agents, infrared absorbers, and pigments.

12. The method of claim 11, wherein said second performance enhancing agent in the third melt is an adhesion control agent.

13. The method of claim 11, wherein said second performance enhancing agent in the third melt is an infrared absorber.

14. The method of claim 9, wherein said second performance enhancing agent in the third melt is a pigment.

15. A method for making a polymer interlayer, comprising:
a) extruding a first poly(vinyl butyral) melt to form a poly(vinyl butyral) sheet; and
b) co-extruding a second poly(vinyl butyral) melt to form a first skin layer on the surface of said poly(vinyl butyral) sheet, wherein said second melt contains a first performance enhancing agent and wherein said first skin layer has a thickness of less than 0.15 millimeters and wherein said first melt is substantially free of said performance enhancing agent; and
c) co-extruding a third poly(vinyl butyral) melt to form a second skin layer on the surface of said poly(vinyl butyral) sheet, opposite to said first skin layer, and having a thickness of less than 0.15 millimeters, wherein said third melt contains a second performance enhancing agent.

16. The method of claim 15, wherein the first performance enhancing agent and the second performance enhancing agent are different performance enhancing agents.

17. The method of claim 15, wherein the first performance enhancing agent and the second performance enhancing agent are the same performance enhancing agents.

18. The method of claim 15, wherein the first and second performance enhancing agents are each selected from the group consisting of adhesion control agents, pigments, dyes, UV absorbers, and infrared absorbers.
